(19) United States
(12) Patent Application Publication
(10) Pub. No.: US 2010/0116821 A1
(43) Pub. Date: May 13, 2010

(54) STRUCTURE HEATING SYSTEM BY MICROWAVE, MICROWAVE OSCILLATION WAVEGUIDE APPARATUS AND MICROWAVE OSCILLATOR COOLING METHOD

(75) Inventors: Norio Niwa, Nagoya-shi (JP); Ryousei Noda, Nagoya-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Kabushiki-Kaisha TAKUMI, Nagoya-shi (JP); Yuugen-Kaisha KANETETUSHOUKAI, Yatomi-shi (JP)

(21) Appl. No.: 12/270,365

(22) Filed: Nov. 13, 2008

(51) Int. Cl. H05B 6/70

(52) U.S. Cl. 219/690

(57) ABSTRACT

A microwave oscillator is effectively cooled and its output characteristic is stabilized, while the waterproof property of the microwave oscillator is secured. Additionally, the heat of the air heated as a result of cooling the microwave oscillator is discharged effectively to maintain the cooling effect. Furthermore, the cooling structure of the microwave oscillator is simplified and downsized and the cost of the arrangement is reduced. A structure includes an air blower member for blowing air to a microwave oscillator and a heat radiating/air circulating member airtightly connected to the terminating end of a microwave waveguide and a shield box so as to be able to cool the air introduced into the microwave waveguide after cooling the microwave oscillator as the air blower member is driven to by turn drive the air to flow from the terminating end toward the shield box. The air in the shield box and the microwave waveguide is enabled to circulate.

### BACKGROUND OF THE INVENTION

1. Field of the Invention

The present invention relates to a structure heating system of melting fallen snow on various structures such as roads (for the purpose of the present invention, roads include those where vehicles and people pass (including roads constructed on bridges) and the rooftops and the roofs of buildings) and walls, preventing snow from piling up and water pooled on surfaces from freezing and melting frozen ice by means of microwave and also to a microwave oscillator cooling method.

2. Description of the Related Art

As described in JP-2006-138172A1, a method of melting snow on a pavement including burying a microwave waveguide equipped with a microwave oscillator in a pavement that contains a microwave absorbing material and causing the microwave absorbing material to absorb the microwave radiated from the microwave waveguide to heat the pavement so as to make it able to melt snow has been proposed.

When using the method in an actual situation, both a microwave waveguide and a microwave oscillator need to be buried in the ground or installed on the ground. In either case, very airtight waterproof measures need to be provided in order to establish electric insulation for them. When the airtight waterproof is not satisfactory, moisture can invades the microwave waveguide. Then, as a microwave propagates through the microwave waveguide, it heats the invading moisture to make it no longer possible to efficiently heat the pavement. Therefore, both the microwave waveguide and the microwave oscillator need to be provided with a very airtight waterproof measures.

On the other hand, the output of a magnetron itself for forming a microwave oscillator becomes instable when it keeps on oscillating because it becomes hot as it oscillates. Then, air needs to be blown to it by means of a cooling fan or the like and cooled by air in order to avoid such a problem.

However, the air used to cool the magnetron needs to be discharged to the outside and fresh external air needs to be taken in order to keep on cooling the magnetron. When the microwave oscillator is provided with highly airtight waterproof measures as described above, it is then difficult to discharge heated air and introduce external air. Then, the magnetron cannot be cooled effectively. While this problem can be dissolved by adopting an arrangement of laying a cooling pipe for flowing a cooling medium and efficiently cooling the magnetron, it entails a problem of inevitably making the cooling structure of the microwave oscillator a complex and large one to consequently raise the cost.

### SUMMARY OF THE INVENTION

According to the present invention, the above-identified problem is solved by providing a structure heating system including:

a structure constructed with a microwave absorbing material contained therein;

a microwave oscillator contained in a shield box buried in the structure to oscillate a microwave of a predetermined frequency and a predetermined output level; and

a microwave waveguide buried in the structure and connected to an output section of the microwave oscillator so as to be able to output a microwave to be propagated in a longitudinal direction toward the microwave absorbing material, and formed by a large number of transmitting sections closed by a microwave non-absorbing material;

the microwave oscillator being adapted to oscillate under control so as to output a microwave from the transmitting sections toward the microwave absorbing material, propagating through the microwave waveguide, and has the microwave absorbing material absorb the microwave and become heated to by turn heat the structure;

an air blower member for blowing air to the microwave oscillator; and

a heat radiating/air circulating member connected airtightly to the terminating end of the microwave waveguide and the shield box so as to be able to cool the air introduced into the microwave waveguide after cooling the microwave oscillator in response to an operation of driving the air blower member in the course of flowing from the terminating end to toward the shield box being provided to make the air in the shield box and the microwave waveguide able to circulate.

Thus, according to the present invention, the microwave oscillator can be effectively cooled and its output characteristic can be stabilized, while the waterproof property of the microwave oscillator is secured. Additionally, according to the present invention, the heat of the air heated as a result of cooling the microwave oscillator can be discharged effectively to maintain the cooling effect. Furthermore, according to the present invention, the cooling structure of the microwave oscillator can be simplified and downsized and the cost of the arrangement can be reduced.

### BRIEF DESCRIPTION OF THE DRAWINGS

FIG. 1 is a schematic illustration of a structure, which is a snow melting heat generation road, embodying the present invention;

FIG. 2 is a schematic longitudinal cross sectional view of part of the snow melting heat generation road of FIG. 1;

FIG. 3 is a schematic illustration of a shield box and a microwave waveguide;

FIG. 4 is a schematic illustration of the terminal end of a microwave waveguide and part of a circulation pipe to be fitted to the microwave waveguide;

FIG. 5 is a schematic illustration of a microwave absorbing material in a state of being heated;

FIG. 6 is a schematic illustration of air being circulated through a shield box and a microwave waveguide;

FIG. 7 is a schematic illustration of a modified example of the microwave waveguide; and

FIG. 8 is a schematic illustration of another modified example of the microwave waveguide.

### DETAILED DESCRIPTION OF THE INVENTION

Now, the present invention will be described in greater detail by way of an embodiment, where the structure of the embodiment is a pavement of a road.

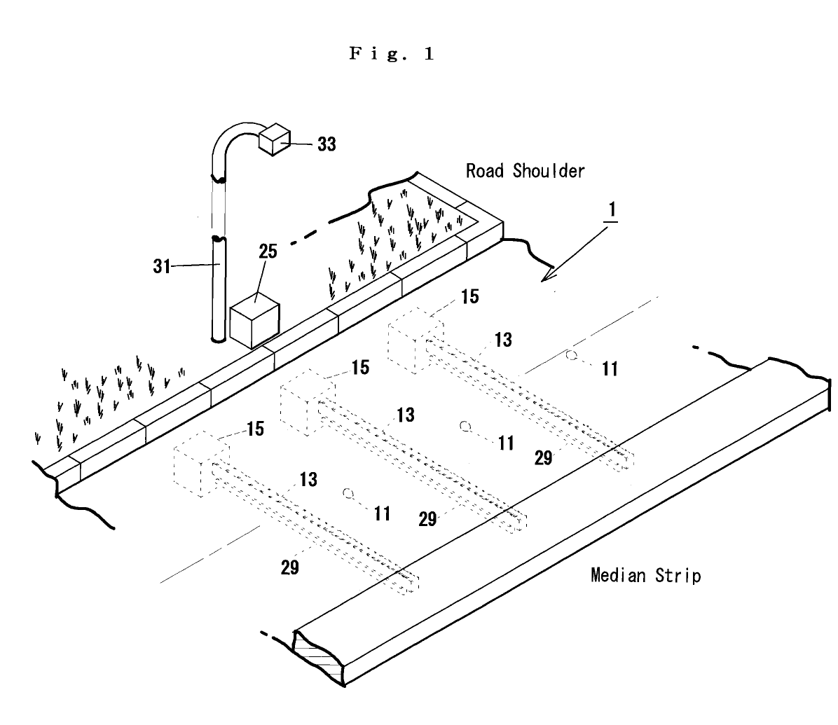

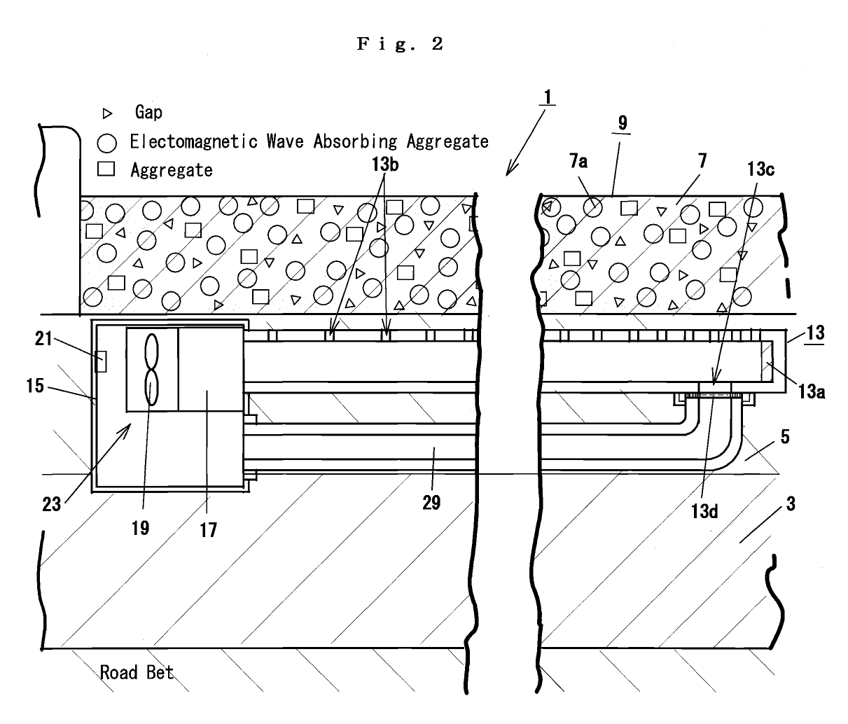

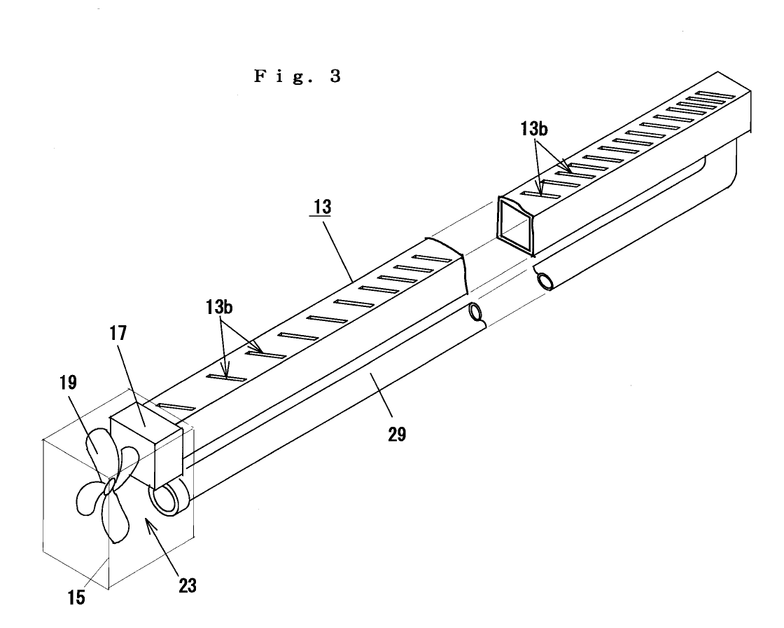

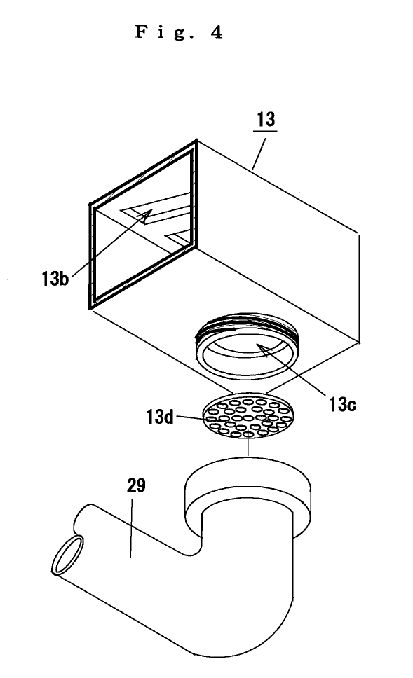

Referring to FIGS. 1 through 4, the structure, which is a snow melting heat generation road 1, is constructed typically by laying a pavement 9 which includes a road base 3 laid on a road bed, a concrete or asphalt base layer 5 laid on the road base 3 and a concrete or asphalt surface layer 7 laid on the base layer 5.

The surface layer 7 is laid on the base layer 5 to a necessary thickness and made of concrete or asphalt containing a microwave absorbing material 7a selected from ferrite (iron oxide), oxidizing slag, ceramics, permalloy, short or long microfibers containing any of the above listed microwave absorbing materials and rubber chips and pellets impregnated with ferrite. Temperature sensors 11 are buried in the surface layer 7 to detect the temperature of the surface layer 9.

When the microwave absorbing material 7a is ferrite (iron oxide), oxidizing slag, ceramics, permalloy or the like, it is regulated to become small pieces with a maximum diameter of about 50 mm and show a content ratio of about 5 to 100% by volume relative to the aggregate 7b contained in the surface layer 7. When, on the other hand, the microwave absorbing material 7a is microwave absorbing fiber, it is regulated to show a content ratio of about 0.01 to 2% by weight relative to the weight of the cement. Suitable microwave absorbing fibers that can be used for the purpose of the present invention include polyamide fiber, glass fiber, polypropylene fiber and acryl fiber. The expression of 100% as used herein refers to an instance where the aggregate 7b to be mixed with concrete or asphalt is entirely a microwave absorbing material 7a.

Preferably, the surface layer 7 contains aggregate 7b such as crushed stones in addition to the above-described microwave absorbing material 7a so that numerous independent gaps and continuous gaps may be produced by the microwave absorbing material 7a and the aggregate 7b. Such gaps operate as a dielectric layer that absorbs microwaves by way of dielectric loss in addition to the microwave absorbing effect of the microwave absorbing material 7a and serve to make the surface layer 7 generate heat efficiently.

Preferably, the microwave absorbing material 7a contained in the surface layer 7 is distributed in the latter such that the concentration of the microwave absorbing material 7a is higher at the road surface side. With such an arrangement, the snow melting heat generation road 1 can generate heat efficiently at the road surface side and reduce the ratio by which the microwave radiated from each microwave waveguide 11 leaks to the outside of the road surface of the snow melting heat generation road 1 as well as reduce microwave troubles to human beings and electronic apparatus mounted in vehicles. The distribution of the microwave absorbing material 7a contained in the surface layer 7 may be defined appropriately according to the relationship of the heat generating efficiency, the microwave leakage and the required road surface strength.

A plurality of microwave waveguides 13 are buried in the base layer 5 of the pavement 9 at regular intervals so as to extend transversally and a shield box 15, which is a precast concrete box or a metal-made box, is entirely or partly buried at the side of one of the opposite ends of each microwave waveguide 13 that is located outside the pavement 9 and airtightly connected to the microwave waveguide 13.

Each shield box 15 contains a microwave oscillation apparatus 23 including a microwave oscillator 17 such as a magnetron, an air blower fan 19 that is an air blower member for forcibly blowing air to the microwave oscillator 17 to cool the latter and a temperature sensor 21 for detecting the surrounding temperature of the microwave oscillator 17. The microwave oscillation apparatus 23 is connected to a control means (not shown) contained in a control box 25 arranged at the corresponding road side or the median strip as will be described hereinafter (although the control box is arranged at the shoulder of the road in FIG. 1, the present invention is by no means limited thereto) by way of an electric cable (not shown). The air blower fan 19 blows cooling air to and around the microwave oscillator 17 and the air heated as a result of cooling the microwave oscillator 17 is introduced into a microwave waveguide 13, which will be described in greater detail hereinafter.

Each microwave oscillator 17 outputs a microwave of a frequency in a microwave frequency band assigned to it by the authority according to the application (e.g., industrial, scientific or medical) and conforming to the Radio Law. For example, the frequency may be 2.45 GHz and the output power may be 0.5 to 5 kW, although the frequency and the output power of the microwave output from the microwave oscillator 17 are by no means limited to the above cited values. The frequency may be selected within a range of about 1 to 20 GHz, while the output power may be selected appropriately according to the road environment such as the environment in a cold district or very cold district. The control box 25 also contains a power supply unit (not shown) and the control means is connected to the temperature sensors 11 buried in the above-described surface layer 7.

Each microwave waveguide 13 that guides the microwave output from the corresponding microwave oscillator 17 is a metal member having a width equal to λ/2 (λ wavelength) of the microwave output from the microwave oscillator 17 with a square or circular cross section (microwave waveguides having a square cross section are shown in the drawings) in the transversal direction, or in the direction orthogonal to the longitudinal direction, of the road and a length equal to the width of the road. Both the inner and outer surfaces of the microwave waveguide 13 are plated by zinc. Each microwave waveguide 13 is connected to the output section of the corresponding microwave oscillator 17 at an end thereof and equipped with a microwave absorbing material 13a in the opposite end thereof.

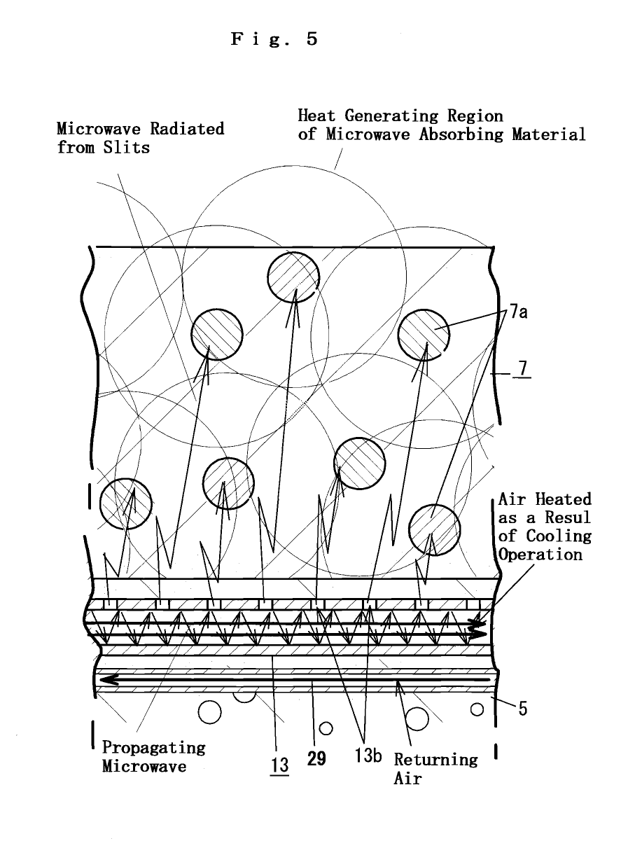

A large number of slits 13b are formed at predetermined regular intervals (λ/4) relative to the longitudinal direction on the upper surface of each microwave waveguide 13 (at the side of the surface layer 7 to be described later). The slits serve as transmitting sections for radiating the microwave being propagated in the inside to the surface layer 7 side. The slits 13b may be formed not on the upper surface as shown in FIG. 5 but at the upper corners of the microwave waveguide 5. The microwave can be output with a uniform output level relative to the surface layer 7 when slits 13b are formed on the microwave waveguide 13 at broader intervals at the side of the microwave oscillator 17 but at narrower intervals at the side opposite to the microwave oscillator 17.

Each microwave waveguide 13 is provided with an opening 13c near the other end thereof and a shield plate 13d is fitted to the opening 13c. The shield plate 13d is a metal plate where a large number of through holes of a size not greater than ¼ of the microwave wavelength are cut so as to limit the external leakage of the microwave propagated in the inside of the microwave waveguide 13 and at the same time allows to discharge air from the inside.

A circulation pipe 29, which is a heat radiating/air circulating member, is airtightly fitted to the peripheral edge of the opening 13c of the microwave waveguide 13. The circulation pipe 29 is typically a synthetic resin pipe made of vinyl chloride or a metal pipe. It is airtightly connected to the shield box 15 containing the microwave oscillation apparatus 23 at the other end thereof.

A waterproof member (not shown) is arranged on the upper surface of each microwave waveguide 13 where a large number of slits 13b are formed so as to airtightly contain the slits 13b. The waterproof member may be silicon resin filled into the slits 13b or a butyl rubber sheet bonded to the upper surface of the microwave waveguide 13 to make the slits 13b waterproof (airtight).

A curved pole 31 is installed to stand at a road side of the snow melting heat generation road 1 with its upper part bending above the snow melting heat generation road 1 and a snow fall sensor 33 is fitted to the top end of the pole 31. The snow fall sensor 33 is connected to the above-described control means to detect the snow fall on the surface of the snow melting heat generation road 1.

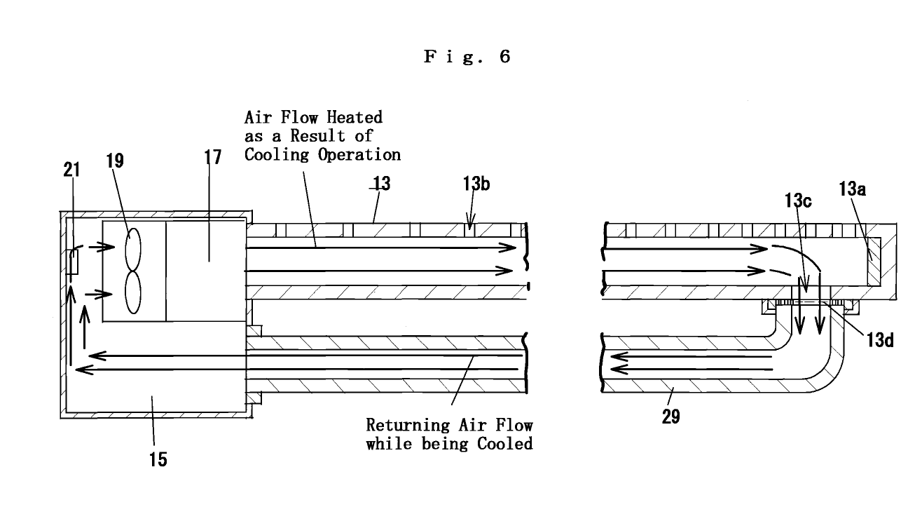

Now, the snow melting operation and the snow melting method of the above-described snow melting heat generation road 1 will be described below by referring FIGS. 5 and 6.

As the temperature sensors 11 buried in the surface layer 7 of the snow melting heat generation road 1 detect the road surface temperature that is at a level that can freeze water, the control means outputs an oscillation drive signal to the microwave oscillator 17b in each shield box 15 to make it oscillate microwaves under control.

As a technique for directing each microwave oscillator 17 to start oscillating, an operator in the road administration office located away from the snow melting heat generation road 1 may output an oscillation start directing signal according to the temperature data obtained by the temperature sensors 11 arranged in the snow melting heat generation road 1 or the snow fall data obtained by the snow fall sensor 33 to drive each microwave oscillator 17 to oscillate.

The microwave that is oscillated by each microwave oscillator 17 propagates in the inside of the corresponding microwave waveguide 13, constantly reflecting therein. On the way of propagation, the microwave is partly transmitted through the slits 13b and radiated toward the surface layer 7. The microwaves that are radiated toward the surface layer 7 are converted to thermal energy due to the magnetic field loss and the dielectric loss produced by the microwave absorbing material 7a contained in the surface layer 7 and the dielectric loss produced by the voids in the surface layer 7 to heat the entire surface layer 7, which is a phenomenon also referred to as microwave absorption. Then, the temperature of the snow melting heat generation road 1 is raised to about 1 to 5° C. by the heat due to the microwave absorption effect produced by the microwave absorbing material 7a and the voids to immediately melt the fallen snow and prevent the water on the road surface from freezing (see FIG. 5).

As the microwave propagating in the inside of each microwave waveguide 13 gets to the terminating end, it is absorbed by the microwave absorbing material 13a. When no microwave absorbing material 13a is arranged at the terminal end of the microwave waveguide 13, the microwave is reflected to propagate toward the starting end to damage the microwave oscillator 17. However, the microwave oscillator 17 is prevented from being damaged as the microwave is absorbed by the microwave absorbing material 13a to eliminate any returning microwave.

While the microwave radiated from the slits 13b of each microwave waveguide 13 is mostly converted to thermal energy by the microwave absorbing material 7a and the voids for absorption, a small part thereof may leak to the outside of the road surface and give rise to microwave troubles to human beings and electronic apparatus mounted in vehicles. However, the leaking microwave can be minimized by raising the concentration of the microwave absorbing material 7a distributed at the road surface side of the surface layer 7 as described above.

When each microwave oscillator 17 is driven to oscillate, the air blower fan 19 is driven to blow air and cool the microwave oscillator 17 by air because the output level needs to be prevented from becoming instable due to an overheated magnetron. Air blown by the air blower fan 19 cools the microwave oscillator 17 to heat itself. Subsequently, it is introduced into the microwave waveguide 13 to flow toward the terminal end and then passes through the holes of the shield plate 13d and further the inside of the circulation pipe 29 before it is returned to the inside of the shield box 15. The leakage of microwave to the outside of the microwave waveguide 13 is limited because the size of the holes of the shield plate 13d is defined to be not greater than ¼ of the wavelength of the microwave.

The heated air that flows into the circulation pipe 29 is forced to flow toward the shield box 15 due to the air suction effect of the air blower fan 19. The heated air is cooled as it flows through the inside of the circulation pipe 29 and hence the microwave oscillator 17 can be cooled efficiently by the air returned to the inside of the shield box 15 (see FIG. 6).

Note that the temperature of the air returned to the inside of the shield box 15 is detected by the temperature sensor 21. When, for instance, the temperature detected by the temperature sensor 21 is not lower than 140° C., the control means stops driving the microwave oscillator 17 to oscillate but continues to drive the air blower fan 19 in order to circulate air in the inside of the shield box 15, the microwave waveguide 13 and the circulation pipe 29 to cool the microwave oscillator 17. When, on the other hand, the temperature detected by the temperature sensor 21 falls below 100° C. for example, the control means starts driving the microwave oscillator 17 to oscillate once again and has it output a microwave.

When the surface layer 6 is heated by the microwave output from the microwave oscillator 17 and the temperature of the surface layer 6 detected by the temperature sensor 11 gets to about 1 to 5° C. for example, the control means stops driving each microwave oscillator 17 to oscillate and output a microwave according to the detection signal from the temperature sensor 11.

When the temperature of the surface layer 6 falls below the above defined temperature after stopping the output of a microwave, the control means once again drives each microwave oscillator 17 to oscillate and output a microwave toward the surface layer 6 in order to heat the latter according to the detection signal from the temperature sensor 11. In this way, each microwave oscillator 17 is controlled according to the temperature detection signal from the temperature sensor 11 so as to intermittently oscillate and keep the temperature of the surface layer 6 substantially to a constant level. Thus, the snow melting heat generation road 1 can keep on melting snow.

This embodiment is adapted to forcibly blow air to each microwave oscillator 17 that is heated as the magnetron is driven to oscillate in order to stabilize the oscillation and the output of the microwave oscillator 17, while circulating the air heated as a result of the cooling operation through inside of the shield box 15 and the microwave waveguide 13, which are held in an airtight condition, by means of the circulation pipe 29, so that the microwave oscillator 17 can be efficiently cooled by air.

Thus, it is no longer necessary to take in external air in order to cool the microwave oscillator 17 and discharge the air heated as a result of cooling the microwave oscillator 17. In other words, the shield box 15 and the microwave waveguide 13 can be held in an airtight condition to prevent troubles that may be caused by invading water or the like.

The above-described embodiment can be modified in the following ways.

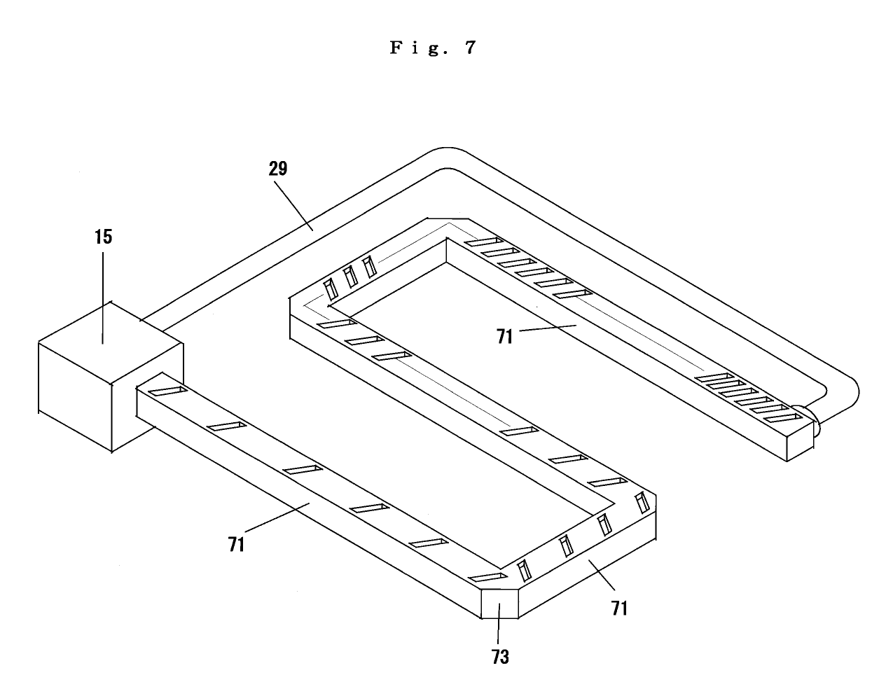

1. While the structure is the pavement of a road in the above description, the structure may alternatively be the roof or the wall of a building, a sidewalk or an approach.
2. While the microwave waveguide 5 is a linear waveguide in the above description, it may be divided into a plurality of unit waveguides 71, which are then connected to show a predetermined angle (90° in the instance of FIG. 7) with a reflector metal plate 73 for reflecting a microwave arranged at each corner so as to make the axial lines of the unit waveguides 71 agree with each other and allow a microwave to propagate in the inside of the unit waveguides 71 as shown in FIG. 7.

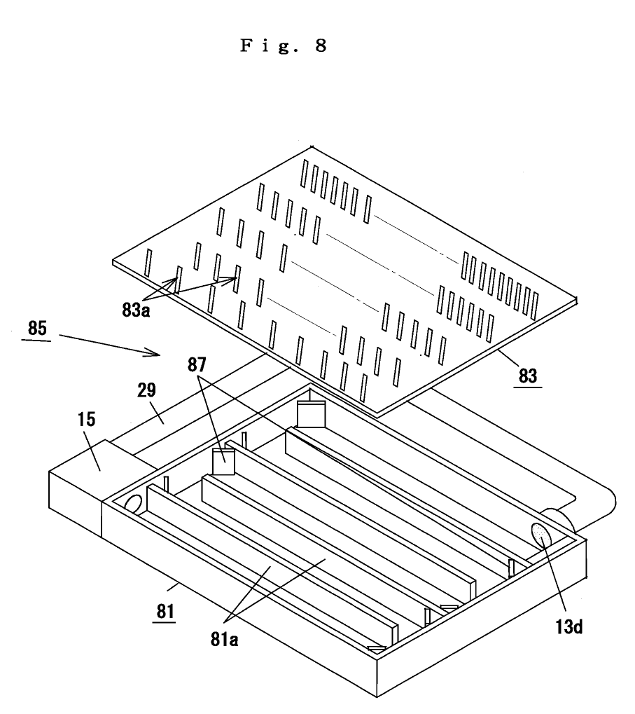

Still alternatively, a microwave waveguide 85 may alternatively be formed in a manner as illustrated in FIG. 8. Referring to FIG. 8, a plurality of partition walls 81a are arranged in a panel 81 to produce a continuous propagation channel and a top plate 83, where a large number of slits 83a are formed along and corresponding to the propagation channel defined by the partition walls 81a, is bonded to the panel 81 to produce an airtight condition in the inside of the microwave waveguide 85. Then, a reflector metal plate 87 is arranged at each corner to turn the microwave propagating in the inside of the propagation channel defined by the partition walls 81a by a predetermined angle.

Note that in FIGS. 7 and 8, the components same as those of the above-described embodiment are denoted respectively by the same reference symbols and will not be described in detail.

3. While the structure is a snow melting heat generation road 1 having a pavement constructed by laying a road base, a base layer and a surface layer on a road bed in the above description, the present invention is by no means limited thereto and applicable to the road structures listed below.
a. A pavement constructed by burying microwave waveguides equipped with respective microwave oscillators in the road base of a road, laying a relatively thin base layer on the road base and subsequently laying a facing surface layer, which may be formed by tiles containing a microwave absorbing material, inter-blocks, slabs (surface-washed-out slabs, color slabs, imitation stone slabs, Braille slabs, etc.) or a semi-flexible pavement formed by injecting cement milk (fiber mixed or oxidizing slag sand mixed) into open graded asphalt.
b. A pavement constructed by burying microwave waveguides equipped with respective microwave oscillators in the road base of a road and laying a surface layer containing a microwave absorbing material on the road base.
c. A pavement constructed by laying a base layer where microwave waveguides equipped with respective microwave oscillators are buried, laying a surface layer and then laying a facing material such as artificial aggregate or natural stones containing a microwave absorbing material on the surface of the surface layer.
d. A pavement constructed by laying a base layer, where microwave waveguides equipped with respective microwave oscillators are buried, laying a surface layer on the base layer and driving a facing material such as artificial aggregate or natural stones into the surface layer under pressure.

It may be needless to say that any of the above listed pavements may be a water permeable structure or a water impermeable structure.

4. While an air blower fan 19 is arranged in each shield box 15 in the above description, an air blower unit may be arranged somewhere along the heat radiating/air circulating member so as to forcibly drive the air in the shield box and the microwave waveguide to circulate.

What is claimed is:

1. A structure heating system comprising:
a structure constructed with a microwave absorbing material contained therein;
a microwave oscillator contained in a shield box buried in the structure to oscillate a microwave of a predetermined frequency and a predetermined output level;
a microwave waveguide buried in the structure and connected to an output section of the microwave oscillator so as to be able to output a microwave to be propagated in a longitudinal direction toward the microwave absorbing material, and formed by a large number of transmitting sections closed by a microwave non-absorbing material;
the microwave oscillator being adapted to oscillate under control so as to output a microwave from the transmitting sections toward the microwave absorbing material, propagating through the microwave waveguide, and has the microwave absorbing material absorb the microwave and become heated to by turn heat the structure;
an air blower member for blowing air to the microwave oscillator; and
a heat radiating/air circulating member connected airtightly to the terminating end of the microwave waveguide and the shield box so as to be able to cool the air introduced into the microwave waveguide after cooling the microwave oscillator in response to an operation of driving the air blower member in the course of flowing from the terminating end to toward the shield box being provided to make the air in the shield box and the microwave waveguide able to circulate.

2. The structure heating system according to claim 1, wherein the air blower member is arranged at the non-output side of the microwave oscillator in the shield box.

3. The structure heating system according to claim 1, wherein the air blower member is arranged at the non-output side of the microwave oscillator arranged along the heat radiating/air circulating member.

4. The structure heating system according to claim 1, wherein the transmitting sections are filled with water impermeable resin and made airtight.

5. The structure heating system according to claim 1, wherein the microwave waveguide is coated by a water impermeable material to cover the transmitting sections.

6. The structure heating system according to claim 1, wherein the microwave waveguide is formed by connecting a plurality of unit waveguides with a required angle and a reflection member is arranged at each connecting section of the unit waveguides so as to make axial lines of the connected unit waveguides agree with each other.

7. The structure heating system according to claim 1, wherein the structure where a microwave waveguide is buried is made to show a high concentration of the microwave absorbing material at the surface layer side to limit the leakage of microwave from the structure.

8. A microwave oscillation waveguide apparatus comprising:
a shield box airtightly containing a microwave oscillator;
a microwave waveguide airtightly fitted to the shield case at an end thereof corresponding to an output section of the microwave oscillator, the microwave propagation length thereof being a predetermined length, a large number of transmitting sections being formed at a surface thereof in a longitudinal direction to allow a microwave to pass through them, each transmitting section being arranged airtight, a microwave absorbing material being arranged in the other end of thereof;
a heat radiating/air circulating member arranged between the terminal end of the microwave waveguide and the shield case to cause the air in the microwave waveguide to flow; and
an air blower member for blowing air to the microwave oscillator and circulating the air flowing into the microwave waveguide to the inside of the shield case by way of the heat radiating/air circulating member.

9. A microwave oscillator cooling method to be used with a structure heating system for heating a structure constructed with a microwave absorbing material contained therein and having a microwave oscillator contained in a shield box buried in the structure to oscillate a microwave of a predetermined frequency and a predetermined output level and a microwave waveguide buried in the structure and connected to the output section of the microwave oscillator so as to be able to output a microwave to be propagated in the longitudinal direction toward the microwave absorbing material, a large number of transmitting sections closed by a microwave non-absorbing material, the microwave oscillator being adapted to oscillate under control so as to output a microwave from the transmitting sections toward the microwave absorbing material, propagating through the microwave waveguide, and has the microwave absorbing material absorb the microwave and become heated to by turn heat the structure, the method comprising:
cooling the air blown to the microwave oscillator and introduced into the microwave waveguide by an air circulating means airtightly connected between the terminating end of the microwave waveguide and the shield box and the air blower member on the way of being returned from the terminating end to the shield box.

10. The microwave oscillator cooling method according to claim 9, wherein the air blower member is arranged at the non-output side of the microwave oscillator in the shield box.

11. The microwave oscillator cooling method according to claim 9, wherein the air blower member is arranged at the non-output side of the microwave oscillator arranged along the heat radiating/air circulating member.

12. The microwave oscillator cooling method according to claim 9, wherein the transmitting sections are filled with water impermeable resin and made airtight.

13. The microwave oscillator cooling method according to claim 9, wherein the microwave waveguide is coated by a water impermeable material to cover the transmitting sections.

14. The microwave oscillator cooling method according to claim 9, wherein the microwave waveguide is formed by connecting a plurality of unit waveguides with a required angle and a reflection member is arranged at each connecting section of the unit waveguides so as to make axial lines of the connected unit waveguides agree with each other.

15. The microwave oscillator cooling method according to claim 9, wherein the structure where a microwave waveguide is buried is made to show a high concentration of the microwave absorbing material at the surface layer side to limit the leakage of microwave from the structure.
